(19) United States
(12) Patent Application Publication
(10) Pub. No.: US 2008/0240280 A1
(43) Pub. Date: Oct. 2, 2008

(54) Intelligent Iterative Switch Diversity

(75) Inventor: Weiyi Li, Fremont, CA (US)

Correspondence Address: Venture Pacific Law, PC, 5201 Great America Parkway, Suite 270, Santa Clara, CA, 95054, US

(73) Assignee: APACEWAVE TECHNOLOGIES CORPORATION, Fremont, CA (US)

(21) Appl. No.: 11/695,556

(22) Filed: Apr. 2, 2007

(51) Int. Cl. H04B 7/02

(52) U.S. Cl. 375/267

(57) ABSTRACT

A method and system to switch among a plurality of antennae used for wireless communications. A first embodiment is a method for using at least one quality metric and at least one time variation indicator of at least one quality metric to selectively switch among a plurality of antennae to maintain wireless communications. A second embodiment is a method using at least one quality metric and at least one time derivative slope of at least one quality metric to selectively switch among a plurality of antennae to maintain wireless communications. These embodiments can be applied in several wireless communication applications using multiple antennae including, but not limited to, WiMAX applications.

### BACKGROUND OF THE INVENTION

1. Field of the Invention

This invention relates to wireless voice and data communications, and more particularly to systems and methods to provide antenna diversity in wireless transmission communication systems.

2. Description of the Prior Art

The Institute of Electrical and Electronic Engineers (IEEE) has established a wireless standard, IEEE 802.16e. The IEEE 802.16e standard (IEEE 802.16e) outlines Media Access Control (MAC) and Physical Layer (PHY) specifications for wireless networks. The specification of the IEEE 802.16e addresses transmission of data in wireless networks. In particular, the IEEE 802.16e standard addresses communication in wireless asynchronous transfer mode (ATM) systems, covering frequencies of operation between 2.5 gigahertz (GHz) and 6 GHz. As is known in the art, IEEE 802.16e uses a modulation method called orthogonal frequency-division multiplexing access (OFDMA), which allows communication to occur at extremely high data speeds by transmitting data over multiple frequency channels over a wide frequency range.

The IEEE 802.16e specification takes into account successful and unsuccessful transmission of packets, for example data packets, and includes mechanisms designed to thwart problems with packet transmission, such as requiring in-order transmission of packets, and retransmission by a transmitting entity of packets that were not received properly by a receiving entity.

The antennae used for the transmission or receipt of these packets play a crucial role. An antenna is a device that transmits or receives electromagnetic wave signals. The signals may be, for example, received by another antenna located at a proximate or a distant location. The antennae may be mounted within, for example, a transmission device in a wireless communication network. Some examples of transmission devices include wireless base station or access point devices, and mobile station devices. One example wireless communication network system is disclosed in the Mobile WiMAX Technical Overview and Performance Evaluation document prepared on behalf of the WiMAX Forum and published on Feb. 21, 2006, which is hereby incorporated by reference.

The mechanism of selecting an antenna from a plurality of antennae to attain a superior channel is called switch diversity. Typically, switch diversity selects a new antenna when directed and continues operations by using the new antenna. Unfortunately, since mobile station devices usually have a single radio chain, it extremely difficult for a mobile station device to determine which antenna offers the best channel without actually using the antenna. Thus, it is likely that the mobile station device will perform worse after the switch to the new antenna. When this occurs, the mobile station device often iterates through untried antennae searching for an antenna that would work. Such antenna search iterations can result in a lengthy interval of service outage for the mobile station device.

Normally, antenna selection is based on the value of a quality metric, related either to the antenna used and/or the communication channel (e.g., an antenna gain figure, a cyclical redundancy check (CRC) parameter, a receive signal strength indicator (RSSI), a carrier to interference+noise ratio (CINR), a signal-to-noise figure, a bit error rate, a symbol error rate, or an equivalent quality metric). The types of quality metrics may also be divided into two major categories: (1) those which are designed to monitor signal transmissions and select an antenna as the signal is received and (2) those which are designed to monitor signal transmissions and select an antenna after the signal is received.

FIG. 1 illustrates a flowchart of a method to switch among a plurality of antennae based on a quality metric, according to the prior art. The sequence starts in operation 102. Operation 104 is next and includes monitoring over time a quality metric relating to the use of a first antenna. Operation 106 is next and includes using the first antenna if the quality metric does not fail, and if the quality metric fails a pre-defined value, switching to another antenna. The method ends in operation 108. In the prior art, it should be noted that the plurality of available antennae is perhaps very small, so that antennae are typically chosen in a round-robin fashion. There is no provision in a prior art antenna selection module for optionally selecting the next antenna based in part on any indicator predicting the quality condition of the first antenna.

In a time division multiplexed access (TDMA) wireless system, for example, the antenna selection is controlled by software or logic circuitry. In this system, a CRC parameter or an equivalent is generally used to select an antenna after the signal is received. CRC is based on polynomial division in which each bit of a packet of data represents one coefficient of a polynomial. The polynomial is then divided by a pre-programmed polynomial to yield a quotient polynomial and in some cases a remainder polynomial. When the division yields a remainder polynomial, the system assumes that a transmission error occurred and selects another antenna. If, however, the division does not yield a remainder polynomial, the system assumes no transmission errors occurred and therefore does not select another antenna.

One example of a current antenna selection process is illustrated in FIG. 2. Comparator 202 receives inputs CRC 204 and CRC threshold 206 as inputs and then produces a result 204 coupled to the next frame antenna selection module 206. A CRC error rate that produces good speech quality is used as a threshold for selecting an appropriate antenna. If the present antenna provides a CRC error that is below the threshold value, no switching occurs. However, when the CRC error rate rises above the threshold value, another antenna is selected.

While CRC provides antenna selection by monitoring transmitted data, it has disadvantages. Its primary shortcoming is that antenna selections are not made in real time. The present antenna selected is based on a previous CRC comparison, which does not change until the antenna receives a poor quality signal. The time delay that exists between receiving an incoming signal and selecting another antenna makes the selection process susceptible to errors due to interference. A CRC selection may be accurate if a transmitter or receiver is stationary or moves at a slow rate of speed, because the communication environment is subject only to slight variations in time. However, when a transmitter or receiver moves at a high rate of speed, this time delayed process may be ineffective because it may not react to a changing environment and thus, it may be susceptible to interference.

Another technique for antenna diversity switching monitors signal transmissions and selects an antenna as the signals are received. Preamble diversity switching is an example of a system that provides real-time measurements and real-time antenna selection. Preamble diversity switching sequentially measures the receive signal strength of a diversity of antennae at the beginning of each extended preamble. The receive signal levels of each antenna, which are the receive signal strength indicators (RSSI), are stored and compared. The antenna with the higher RSSI value is selected. When the RSSI value associated with another antenna is higher, that antenna is then selected.

The preamble diversity switching process provides the benefit of selecting an antenna as signals are received. The system is less affected by rapid environmental change. However, problems arise when differences between RSSI values are insignificant. When insignificant differences exist, the system may experience some uncertainty when selecting an antenna. This is simply because minor differences in RSSI values indicate that the signal qualities received by the antennae are similar and therefore, an antenna selection will not necessarily improve receiving quality. Therefore, a conventional preamble diversity switching process may not be the best method for selecting an antenna.

It is not unusual for an antenna to receive a signal across a fading channel. Multiple antennae are typically used in communication systems to provide another option to turn to, in the event of poor signal reception due to a fading channel, so that a good channel with no fading can be found. Some examples of causes of a fading channel include phase shift in the signal and multi-path interference errors. The RF energy that is transmitted between antennae can experience destructive and constructive interference due to multiple paths taken by the energy with multiple delays on the way to a receive antenna. The interference can cause a receive antenna to receive a packet in error or to miss a packet entirely.

Ideally, antenna diversity techniques are used when a particular channel is fading due to multi-path effects so that changing from one antenna to another antenna provides another communication channel that in all probability is not fading. Trying and testing multiple antennae using antenna diversity typically takes place during a preamble, header, or training portion of the packet. The preamble is examined rather than the data so that no data are lost while the different antennae are being tested.

There are several reasons why this approach is undesirable for the IEEE 802.16e standard, and for any other high data rate radio system. First, the packet preamble in IEEE 802.16e is quite short, because a short preamble is desirable in any high data rate communications system in order to keep the efficiency of the communications system high. If the preamble is a long period in time, then the efficiency is low. While having a short preamble is good for efficiency, the short preamble reduces the time available to test the antennae. Switching between antennae takes a certain time based on the physical constraints of driving electrical switches. In addition, there is a minimum time needed to measure the signal from a given antenna to effectively determine the quality of the signal. When the measurement time (i.e., the duration of the preamble) is very short, a very poor estimate of the quality may be obtained.

In contrast to IEEE 802.16e systems, most wireless systems are narrowband signal systems. Narrowband signals are generally thought of in terms of having signal bandwidths of hundreds of kilohertz (kHz), for example, 500 kHz or 1 megahertz (MHz), or less, depending on the transmitting and receiving channel response. Wideband and broadband signals are generally thought of in terms of having signal bandwidths above 1 MHz depending on the transmitting and receiving channel response. In IEEE 802.16e systems, the signals have operating carrier frequencies in the neighborhood of 2-6 GHz.

At higher frequencies the signal more directional and more easily interrupted by relative movements of the transmitter and/or receiver. Furthermore, at higher frequencies the amount of data transmitted in a unit of time increases, creating a need to avoid or minimize interruptions caused by antenna failure. Therefore, an antenna switching algorithm should be optimized as much as possible to deal with the greater vulnerabilities and consequences of higher frequency and faster data transmission environments.

In view of the foregoing, what is needed is an improved method and system to more closely optimize the selection of an antenna from a plurality of antennae when an antenna and/or channel is degrading during use. Wideband wireless antenna applications and narrowband wireless antenna applications could both benefit from such methods and systems.

### SUMMARY OF THE INVENTION

The present invention can be implemented in numerous ways, such as by a method, a circuit, or a system. Two aspects of the invention are described below.

A first aspect of the invention is directed to a method to switch among a plurality of antennae based on at least one quality metric. The method includes monitoring over a first period of time a first quality metric relating to the use of a first antenna, and determining a time variation indicator of the first quality metric; storing the time variation indicator of the first quality metric in a first memory location; and switching to a second antenna; monitoring over a second period of time a second quality metric relating to the use of the second antenna, if the second quality metric relating to the use of the second antenna fails the pre-defined quality metric value, and the time variation indicator of the first quality metric is small, switching back to the first antenna and repeating substantially all preceding operations to switch to a third antenna when necessary; if the second quality metric relating to the use of the second antenna fails the pre-defined quality metric value, and the time variation indicator of the first quality metric is large, switching to a third antenna and repeating substantially all preceding operations with the third antenna substituted for the first antenna.

A second aspect of the invention is directed to a method to switch among a plurality of antennae based on at least one quality metric. The method includes monitoring over a first period of time a first quality metric relating to the use of a first antenna, and determining a time derivative slope of a first quality metric; if the first quality metric does not fail a pre-defined quality metric value, remaining with the first antenna; if the first quality metric fails the pre-defined quality metric value; storing the time derivative slope of the first quality metric in a first memory location; switching to a second antenna; monitoring over a second period of time a second quality metric relating to the use of the second antenna; if the second quality metric does not fail the pre-defined quality metric value, remaining with the second antenna; if the second quality metric relating to the use of the second antenna fails the pre-defined quality metric value, and the time derivative slope of the first quality metric has an absolute value less than a pre-defined time derivative slope threshold, switching back to the first antenna and repeating substantially all preceding operations to switch to a third antenna when necessary; if the second quality metric relating to the use of the second antenna fails the pre-defined quality metric value, and the time derivative slope of the first quality metric has an absolute value not less than the pre-defined time derivative slope threshold, switching to a third antenna and repeating substantially all preceding operations with the third antenna substituted for the first antenna.

These and other aspects and advantages of the invention will become apparent to those skilled in the art from the following detailed description of the invention and the accompanying drawings.

### BRIEF DESCRIPTION OF THE DRAWINGS

FIG. 1 illustrates a flowchart of a conventional antenna switching process for a plurality of antennae, in accordance with the prior art.

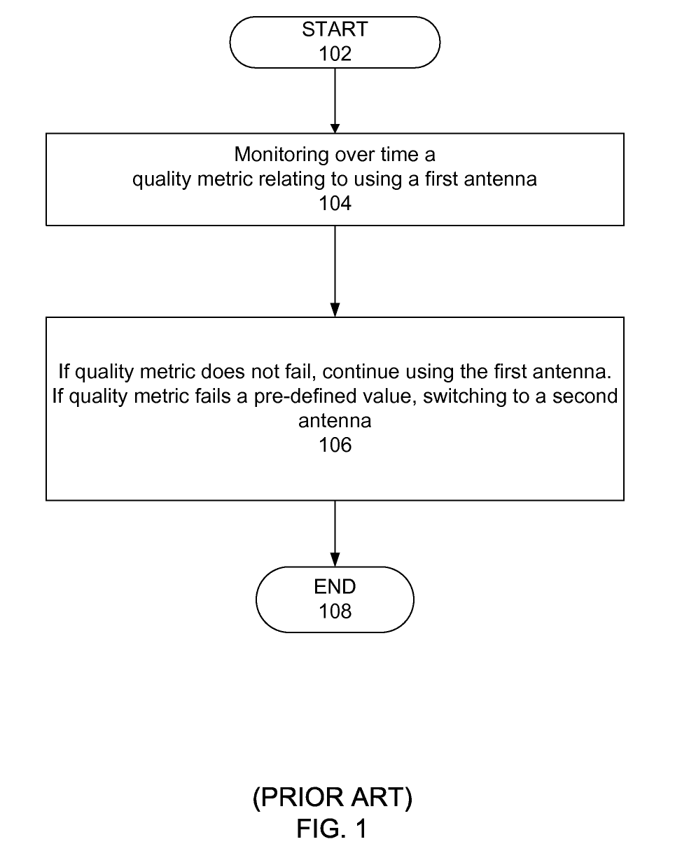

FIG. 2 illustrates a comparator for comparing CRC values, in accordance with the prior art.

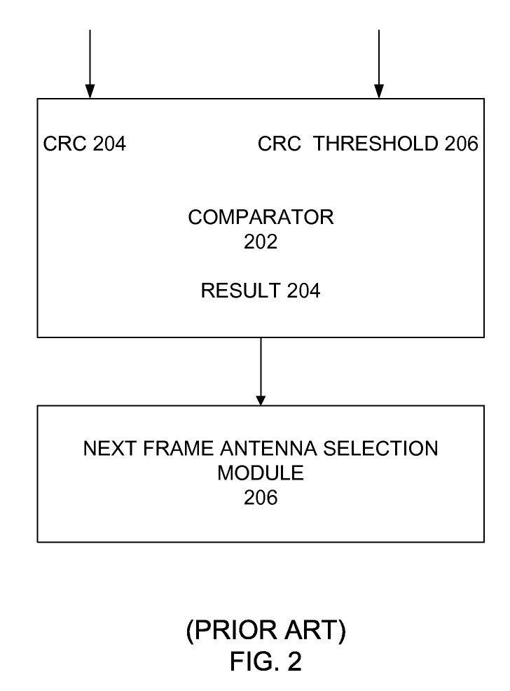

FIG. 3 illustrates one example of how an antenna is selected, according to one embodiment of the invention.

FIG. 4 illustrates a block diagram of a wireless station transmitter/receiver and an antenna switch, according to one embodiment of the invention.

FIG. 5 illustrates a linear interpolation of successive samples of the quality metric(s), in accordance with one embodiment of the invention.

FIG. 6 illustrates a plot of a quality metric versus time, in relation to a switch threshold and a margin for hysteresis, and a failure threshold, a switch time, a margin of time for hysteresis, and a failure time, in accordance with one embodiment of the invention.

FIG. 7 illustrates a state diagram of the quality metric testing and antenna transitions, in accordance with one embodiment of the invention.

FIG. 8 illustrates a flowchart of a method to switch among a plurality of antennae based on at least one quality metric, according to one embodiment of the invention.

FIG. 9 continues the flowchart of FIG. 8 of a method to switch among a plurality of antennae based on at least one quality metric, according to one embodiment of the invention.

FIG. 10 illustrates a flowchart of a method to switch among a plurality of antennae based on a quality metric, in accordance with one embodiment of the invention.

FIG. 11 illustrates a flowchart of a method to switch among a plurality of antennae, in accordance with one embodiment of the invention.

### DETAILED DESCRIPTION OF THE PREFERRED EMBODIMENT

The invention provides a method and a system to more closely optimize the selection of antennae in wireless communication systems. Various embodiments of the invention can be applied to communication applications, biological applications, medical applications, electronic applications, and any other applications where a better antenna or channel selection algorithm can be beneficially used in communications. In this specification, drawings, and claims, any instance of the term radio-frequency is defined as any electromagnetic signal frequency in the frequency range of 50,000 to 100,000,000,000 cycles per second (Hertz).

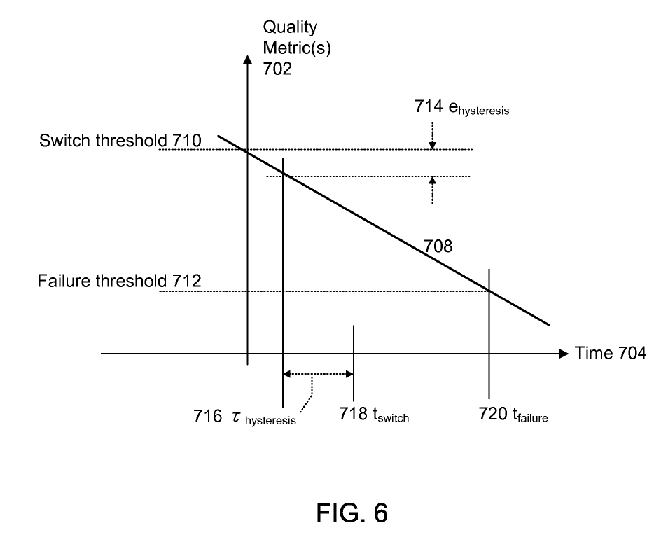

Other terms used below and in the figures are defined as follows. Thres_{sw}—This is the switch threshold. This is the point at which degradation of antenna or channel condition (e.g., determined by at least one metric of quality) indicates that a switch is necessary. The antenna or channel is still usable until its quality falls below the failure threshold. This can be computed from simulated performance of the device. Thres_{failure}—This is the failure threshold. This is the point at which degradation of the antenna or channel condition indicates that the current antenna or channel is unusable. This can be computed from a simulated performance of the device. ε_{hysteresis}—This is a factor that adds additional margin to ensure an antenna or channel switch is performed at the proper condition. τ_{hysteresis}—This is the interval needed to determine whether an antenna or channel switch is needed. The antenna or channel condition must be below the switch threshold for this amount of time before an antenna or channel switch is attempted. These parameters are illustrated below in FIG. 6.

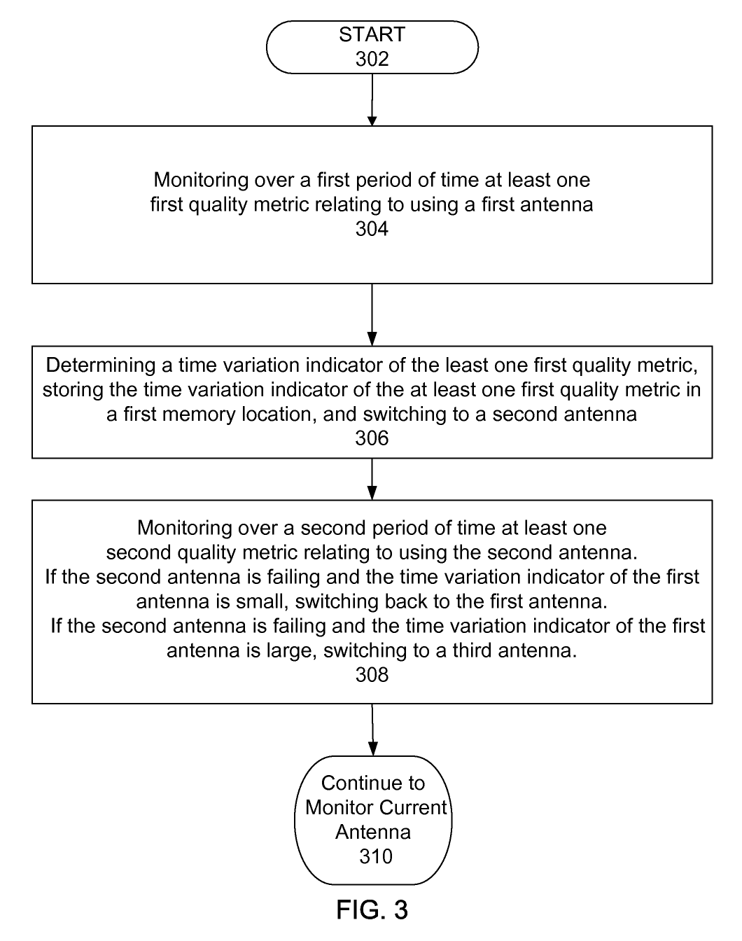

FIG. 3 illustrates a flowchart of a method to switch among a plurality of antennae based on at least one quality metric, according to one embodiment of the invention. The sequence starts in operation 302. Operation 304 is next and includes monitoring over a first period of time at least one first quality metric relating to the use of a first antenna. Operation 306 is next and includes determining a time variation indicator of the at least one first quality metric, storing the time variation indicator of the at least one first quality metric in a first memory location, and switching to a second antenna. The time variation indicator in certain embodiments is a calculated time derivative of at least one quality metric, an average time derivative over a period of time, a difference in quality metric values over a delta of time, an interpolation or extrapolation of a plurality of values for at least one quality metric, or an equivalent indicator of how one or more quality metrics are changing over time. Operation 308 is next and includes monitoring over a second period of time at least one second quality metric related to using the second antenna. If there is at least one second quality metric failing the pre-defined value and the time variation indicator of the first antenna is small, switching back to the first antenna. If there is at least one second quality metric failing the pre-defined value and the time variation indicator of the first antenna is not small, switching a third antenna. The method continues to monitor the current antenna and ends in operation 310.

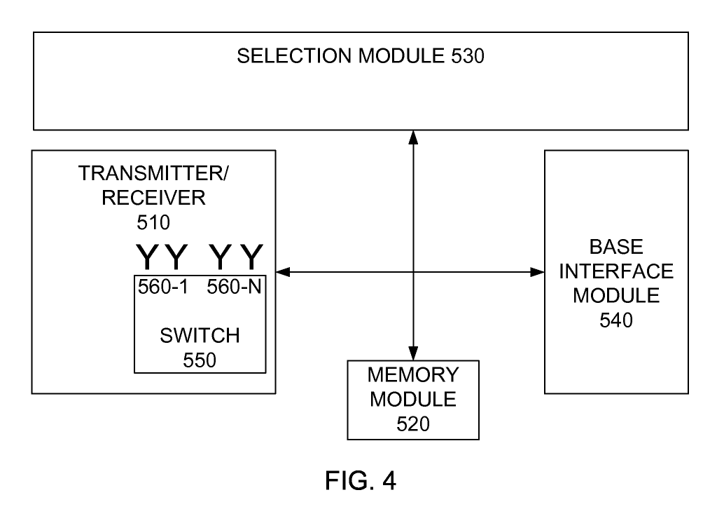

FIG. 4 is a block diagram illustrating major modules of a wireless communication system, according to one embodiment of the invention. In this embodiment, the transmission system is IEEE 802.16e compliant. The communication system includes a transmitter/receiver (T/R) 510, a memory module 520, a bus interface module (BIM) 540, a selection module 530 (e.g., a combined hardware/software module that can also select packets for transmission), and a switch module 550. An antenna table 570 can be optionally included, either inside or outside of the switch module 550, in an alternative embodiment of the invention. The selection module 530 transfers packets from the BIM 540 into the memory module 520. In addition, the selection module 530 queues packets for the T/R 510 so that the selection module 530 can control the order in which packets are sent. The T/R 510 includes two or more wireless transceivers, for example, antennae 560-1, . . . , 560-N, for transmission and reception of RF energy and the switch module 550 to switch between the antennae 560-1, . . . , 560-N. In one embodiment, the number of antennae N is equal to four, and the T/R 510 includes the antennae 560-1, 560-2, 560-3, and 560-4. More generally, this wireless communication system is not limited to two antennae, and any number N of antennae may be used as suitable, subject to any technological, environmental, manufacturing, or performance limitations.

Switch diversity, by definition, is the process of selecting a single antenna with an acceptable quality metric (e.g., an antenna quality, channel quality, or equivalent) at a given time. Quality can be quantified by a set of one or more quality metrics. Various embodiments of the invention can:
1. detect a trend of degradation for the current antenna based on some quality metrics,
2. based on (1), perform an appropriate switch to another antenna and determine its state in the context of quality metrics, and
3. based on (2), perform an appropriate recovery switch if required and permitted by conditions in (1) and (2).

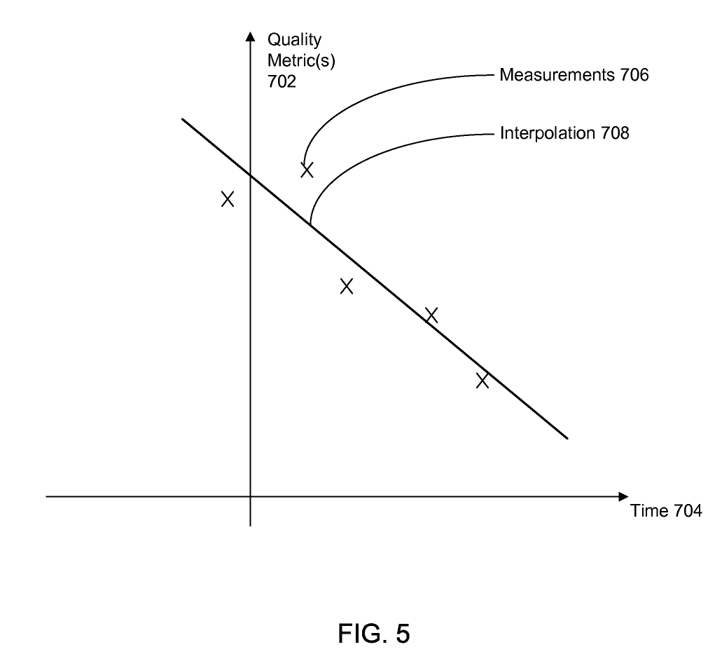

One way to describe the trend of channel degradation can use a linear interpolation of successive samples of at least one quality metric. FIG. 5 illustrates a linear interpolation of successive samples of the quality metric(s), in accordance with one embodiment of the invention. Here, the vertical axis, the quality metric(s) 702, and the horizontal axis, time 704, are illustrated with the interpolation 708 of the quality metric(s) 706. Several types of interpolation methods can be used in various embodiments of the invention, such as a least squares fit with some polynomial interpolation, such as a first order or higher order polynomial. Note that the speed at which an antenna and/or channel degrades is related to the slope of the interpolation, in this embodiment of the invention.

FIG. 6 illustrates a plot of at least one quality metric with hysteresis in a quality metric and in time, in accordance with one embodiment of the invention. Here, the hysteresis in the vertical axis, the quality metric(s) 702, and in the horizontal axis, time 704, are both illustrated. The interpolation 708 of the quality metric(s) measurements is also shown, with a switch threshold 710, a failure threshold 712, a hysteresis 714, a time hysteresis 716, a switch time 718, and a failure time 720. There is typically a lag in the quality metric(s) and in the switching time involved during the determination of whether to switch to a new antenna/link.

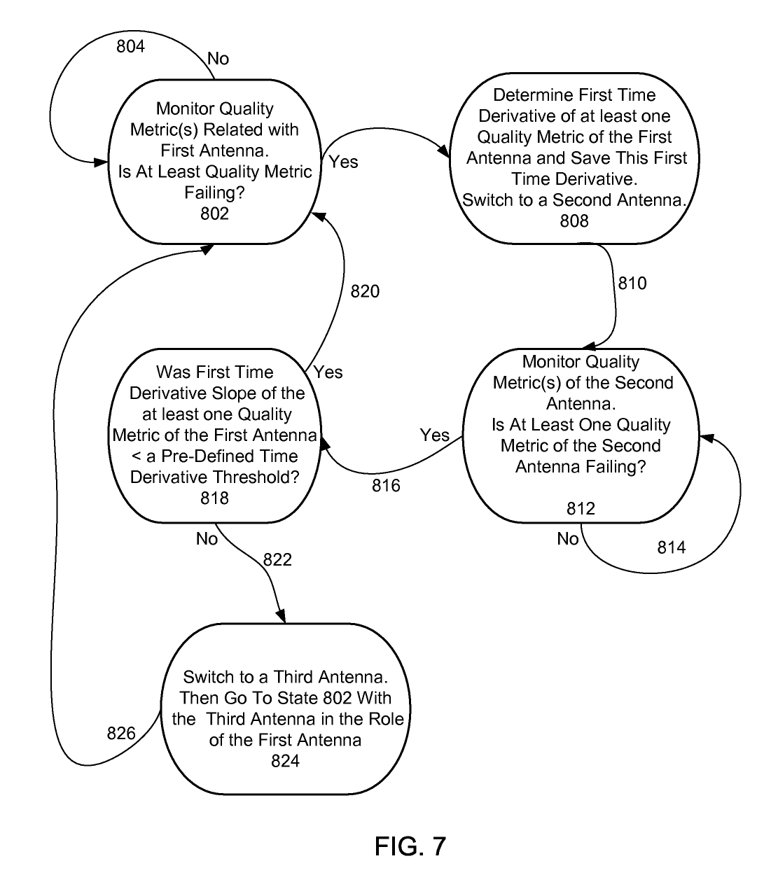

FIG. 7 illustrates a state diagram of the quality metric testing and antenna transitions, in accordance with one embodiment of the invention. State 802 includes monitoring at least one quality metric related with a first antenna, and testing if there is a failure by at least one quality metric. If there is no failure, there is a repeat 804 of state 802. If there is a failure, there is a jump 806 to state 808. State 808 includes determining a first time derivative slope of at least one quality metric of the first antenna, saving this first time derivative slope, and switching to a second antenna with a jump 810 to state 812. State 812 includes monitoring the quality metric(s) of the second antenna, and testing if at least one of the quality metrics of the second antenna fails a pre-defined threshold. The pre-defined threshold in certain embodiments is a pre-defined value, a pre-defined value combined with a hysteresis value adjustment, or an equivalent threshold to determine failure. If there is no failure, there is a jump 814 back to state 812. If there is a failure, there is a jump 816 to state 818. State 818 includes determining if the first time derivative slope of the at least one quality metric of the first antenna is less than (or does not meet) a pre-defined time derivative threshold. A time derivative slope in certain embodiments is a first derivative of at least one quality metric, an average time derivative calculated over a period of time for at least one quality metric, a difference in the value of at least one quality metric sampled at two different times, an interpolation or an extrapolation of a plurality of values of at least one quality metric, or an equivalent indicator of how the at least one quality metric is changing over time. If the first time derivative slope is less than the pre-defined time derivative threshold, then there is a jump 820 back to the first antenna in state 802. If the first time derivative slope is not less than (or meets) the pre-defined time derivative threshold, then there is a jump 822 to state 824, which includes switching to a third antenna, then making a jump 826 to state 802 with the third antenna in the role of the first antenna.

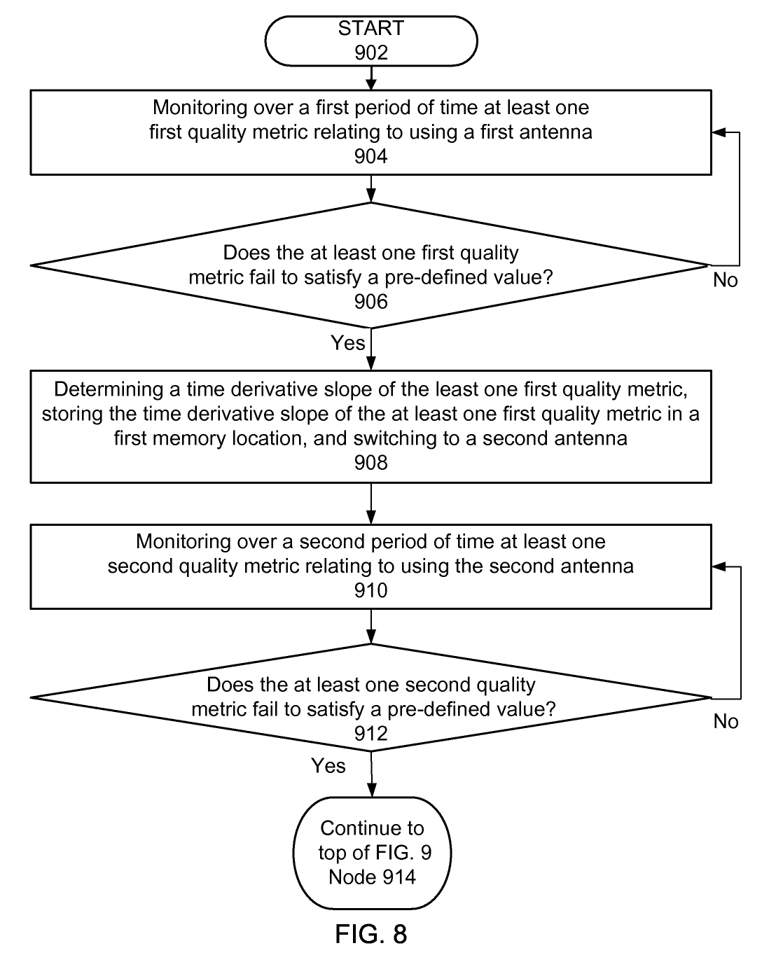

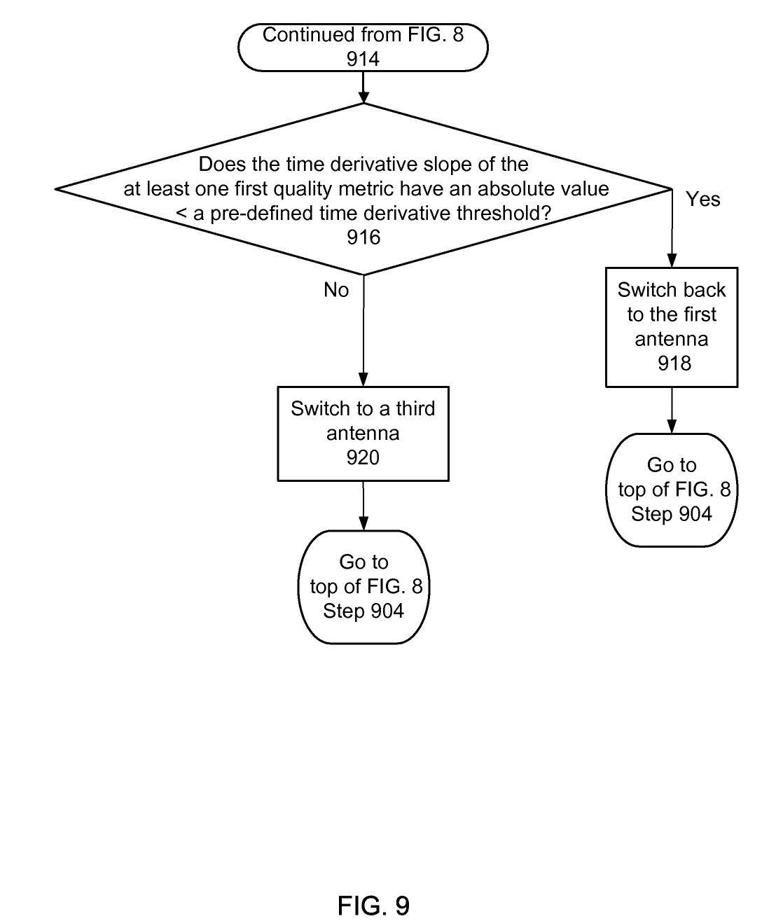

FIG. 8 illustrates a flowchart of a method to switch among a plurality of antennae based on at least one quality metric, according to one embodiment of the invention. The sequence starts in operation 902. Operation 904 is next and includes monitoring over a first period of time at least one first quality metric relating to the use of a first antenna. Operation 906 is next and includes testing if the at least one first quality metric fails a pre-defined quality metric value. If there is no quality metric failure, remain with the first antenna and operation 904 is next. If there is at least one quality metric failure of a pre-defined value, then operation 908 is next. Operation 908 includes determining a time derivative slope of the at least one first quality metric and storing the time derivative slope of the at least one first quality metric in a first memory location, switching to a second antenna. Operation 910 is next and includes monitoring over a second period of time at least one second quality metric relating to the use of the second antenna. Operation 912 is next and includes testing if the at least one second quality metric fails a pre-defined quality metric value. If there is no quality metric failure, remain with the second antenna and operation 910 is next. If there is at least one second quality metric failure of the pre-defined value, then operation 916 on FIG. 9 is next.

FIG. 9 continues to illustrate the FIG. 8 flowchart of a method to switch among a plurality of antennae based on at least one quality metric, according to one embodiment of the invention. Operation 916 includes testing if the time derivative slope of the at least one first quality metric has an absolute value less than a pre-defined time derivative slope threshold. If the derivative slope of the at least one first quality metric has an absolute value less than a pre-defined time derivative slope threshold, then operation 918 is next and includes switching back to the first antenna and going back to operation 904 on FIG. 8. If the time derivative slope of the at least one first quality metric has an absolute value not less than the pre-defined time derivative slope threshold, then operation 920 is next and includes switching to a third antenna and going back to operation 904 on FIG. 8 to repeat substantially all the preceding operations with the third antenna substituted for the first antenna.

In one embodiment, failing a pre-defined value for least one first quality metric could mean the quality metric decreases with decreasing quality and fails by falling below a pre-defined quality metric value. In another embodiment, the quality metric may increase with decreasing quality and fail by going above a pre-defined value. In one embodiment of the invention, a plurality of quality metrics may be used and some weighted average of the plurality of quality metrics is used to determine whether an antenna and/or a channel in use is failing to satisfy some pre-defined value.

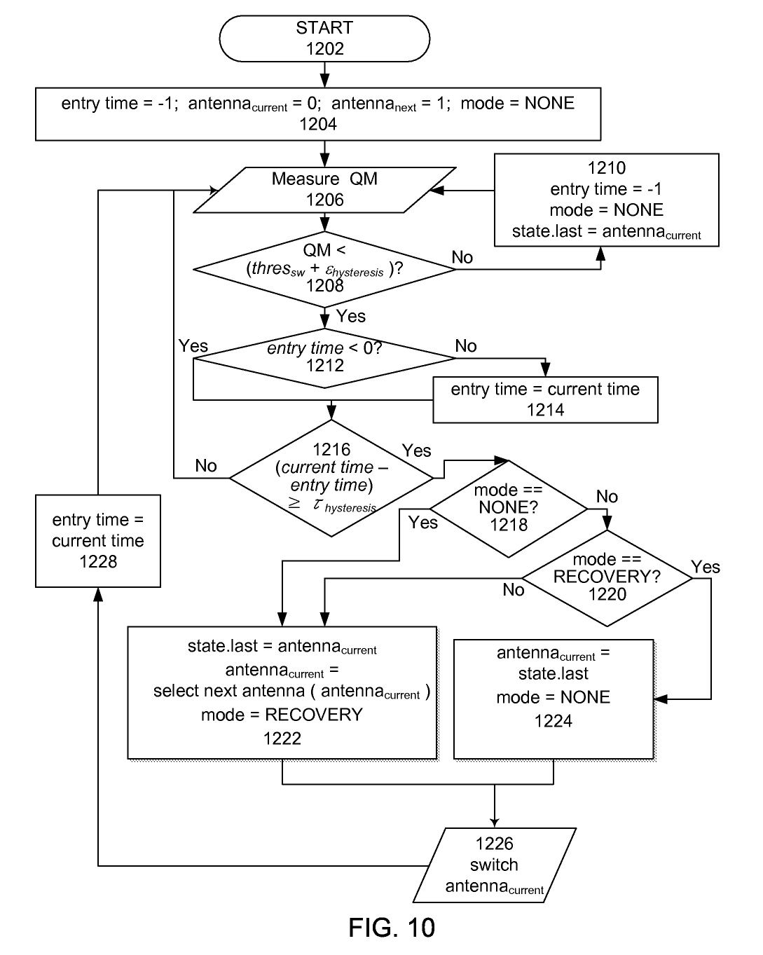

FIG. 10 illustrates a flowchart of a method to switch among a plurality of antennae based on a quality metric, in accordance with one embodiment of the invention. The sequence starts in operation 1202. Operation 1204 is next and includes setting the following parameters with the following values: entry time=−1 (this is the time at which the switch condition is first encountered, a negative value indicates that no entry has been made); antenna_{current}=antenna #0 (the antenna currently used); mode=none (switch mode, and either none (no switch) or recovery (next switch will be switched back). Operation 1206 is next and includes measuring at least one quality metric. Then operation 1208 is next and includes testing at least one quality metric measurement of antenna and/or channel quality. If the quality metric>(thres_{sw}+ε_{hysteresis}), then the switch condition is not met. Operation 1210 is next and includes entry time=−1; state.last=antenna_{current}; and mode=none. Operation 1210 represents steady operations when no antenna switch is required. Operation 1206 is then repeated. However, if the quality metric is not>(thres_{sw}+ε_{hysteresis}), then operation 1212 is next in preparation for a possible antenna switch, which includes a test if (entry time<0). If the test of operation 1212 is false, then this operation seeks to switch to another antenna and records when the switch occurs. Operation 1214 is next and includes setting the entry time=current time, because this is the first encounter using the new antenna. However, if the test of operation 1212 is true, it represents the system may need to recover from an unsatisfactory switch back to the previously used antenna. At this point, operation 1216 is next and includes a test if ((current time−entry time)≧τ_{hysteresis}). If the test result of operation 1216 is yes, indicating that the system has observed this condition for an extended amount of time, then operation 1218 is next and it includes a test if (mode==none?). If the test result of operation 1218 is yes, indicating a need to switch to a new antenna, the next switch will be to the next antenna, then operation 1222 is next and includes calling routines including state.last=antenna_{current}; antenna_{current}=select next antenna (antenna_{current}); and mode=recovery. If the test result of operation 1218 is no, then operation 1220 is next and includes testing if (mode==recovery? which is the recovery mode to switch back to the previous antenna). If the result of the test of operation 1220 is no, indicating the default behavior of switching to a new antenna, then operation 1222 is next. If the result of the test of operation 1220 is yes, indicating a need to switch to the previously used antenna, then operation 1224 is next for a reset, and includes setting antenna_{current}=state.last for the reuse of the previously used antenna; and mode=none. After operation 1222 or operation 1224, operation 1226 is next and includes invoking a routine for the physical antenna switch, such as switch antenna (antenna_{current}). Operation 1228 is next and includes setting the entry time=current time, which is the entry time to the new antenna. Operation 1206 would be repeated next.

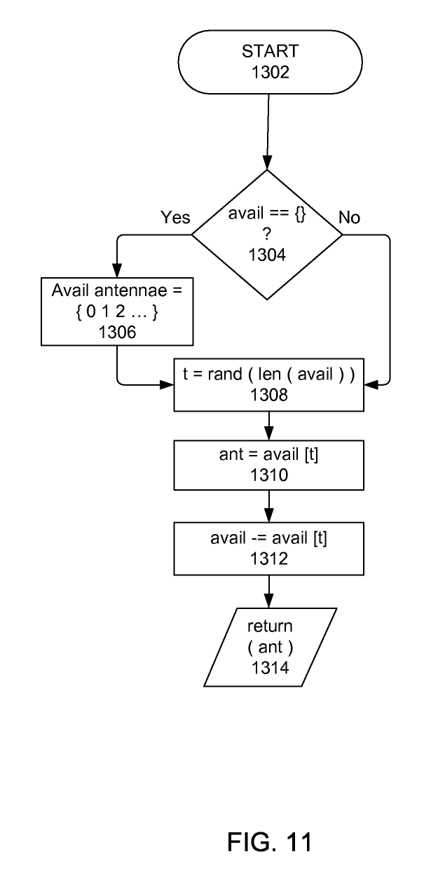

FIG. 11 illustrates a flowchart of a method to select among a plurality of available antennae, in accordance with one embodiment of the invention. The sequence starts in operation 1302. Operation 1304 is next and includes testing if a candidate antenna is not available. If the test result of operation 1304 is yes, then operation 1306 is next and includes populating a list of antennae available to perform a switch, followed by operation 1308. If the test result of operation 1304 is no, then operation 1308 is next and includes setting the parameter t, which in this embodiment randomly selects the next candidate antenna to be used from the list of available antennae. Other embodiments of the invention can use non-random selection criteria. Operation 1310 is next and includes setting parameter ant with the avail time t. Operation 1312 is next and includes removing the selected antenna from the available list of antennae. Operation 1314 is next and includes returning the value of the parameter ant.

Several embodiments of the invention are possible. The phrase “in one embodiment” used in the specification can refer to a new embodiment, a different embodiment disclosed elsewhere in the application, or the same embodiment disclosed earlier in the application. The exemplary embodiments described herein are for purposes of illustration and are not intended to be limiting. Therefore, those skilled in the art will recognize that other embodiments could be practiced without departing from the scope and spirit of the claims set forth below.

What is claimed is:

1. A method to switch among a plurality of antennae based on at least one quality metric, comprising:
monitoring over a first period of time at least one first quality metric relating to the use of a first antenna;
determining a time variation indicator of said at least one first quality metric and storing said time variation indicator of said at least one first quality metric in a first memory location and switching to a second antenna;
monitoring over a second period of time at least one second quality metric relating to the use of said second antenna;
if said at least one second quality metric relating to the use of said second antenna fails said pre-defined quality metric value, and said time variation indicator of said at least one first quality metric meets a pre-defined threshold, switching back to said first antenna; and
if said at least one second quality metric relating to the use of said second antenna fails said pre-defined quality metric value, and said time variation indicator of said at least one first quality metric does not meet said pre-defined threshold, switching to a third antenna.

2. The method of claim 1, further comprising:
updating a plurality of memory locations to indicate a previous antenna, a current antenna, and a next antenna.

3. The method of claim 1, further comprising:
if said at least one second quality metric relating to the use of said second antenna fails said pre-defined quality metric threshold, updating at least one index regarding said second antenna with said at least one quality metric relating to the use of said second antenna, and said time variation indicator of said at least one second quality metric.

4. The method of claim 1, wherein said at least one quality metric must fail a pre-defined quality metric value that is determined by a pre-defined quality metric threshold and a pre-defined quality metric margin, before starting a switch to said second antenna.

5. The method of claim 1, wherein said at least one quality metric must fail a pre-defined quality metric value that is determined by a pre-defined quality metric threshold and a pre-defined quality metric margin, for a pre-defined period of time, before starting a switch to said second antenna.

6. The method of claim 1, wherein said first antenna, said second antenna, and said third antenna are used in wideband applications substantially compatible with IEEE 802.16e requirements.

7. The method of claim 1, wherein said at least one quality metric must fail a pre-defined quality metric value that is determined by a pre-defined quality metric threshold and a pre-defined quality metric margin, for a pre-defined period of time not greater than a frame of 5 milliseconds before starting a switch to said second antenna.

8. The method of claim 1, wherein said second antenna is chosen in a pre-defined sequence from a plurality of available antennae.

9. The method of claim 1, wherein said second antenna is chosen at random from a plurality of available antennae.

10. A method to switch among a plurality of antennae based on at least one quality metric, said method comprising:
monitoring over a first period of time at least one first quality metric relating to the use of a first antenna;
if said at least one first quality metric does not fail a pre-defined quality metric value, remaining with said first antenna;
if said at least one first quality metric fails said pre-defined quality metric value;
determining a time derivative slope of said at least one first quality metric and storing said time derivative slope of said at least one first quality metric in a first memory location;
switching to a second antenna;
monitoring over a second period of time at least one second quality metric relating to the use of said second antenna;
if said at least one second quality metric does not fail said pre-defined quality metric value, remaining with said second antenna;
if said at least one second quality metric relating to the use of said second antenna fails said pre-defined quality metric value, and said time derivative slope of said at least one first quality metric has an absolute value less than a pre-defined time derivative slope threshold,
switching back to said first antenna and repeating substantially all preceding operations to switch to another antenna when necessary; and
if said at least one second quality metric relating to the use of said second antenna fails said pre-defined quality metric value, and said time derivative slope of said at least one first quality metric has an absolute value not less than said pre-defined time derivative slope threshold,
switching to a third antenna and repeating substantially all preceding operations with said third antenna substituted for said first antenna.

11. The method of claim 10, further comprising:
updating a plurality of memory locations to indicate a previous antenna, a current antenna, and a next antenna.

12. The method of claim 10, wherein said first antenna, said second antenna, and said third antenna are used in wideband applications substantially compatible with IEEE 802.16e requirements.

13. The method of claim 10, wherein said at least one quality metric must fall below a pre-defined quality metric value determined by a pre-defined quality metric threshold and a pre-defined quality metric margin before starting a switch to said second antenna.

14. The method of claim 10, wherein said at least one quality metric must fall below a pre-defined quality metric value determined by a pre-defined quality metric threshold and a pre-defined quality metric margin for a pre-defined period of time before starting a switch to said second antenna.

15. A method to switch among a plurality of antennae based on a quality metric, said method comprising:
monitoring over a first period of time a first quality metric relating to the use of a first antenna;
if said first quality metric does not fall below a pre-defined quality metric value, remaining with said first antenna, and updating a plurality of memory locations with a time entry, a mode entry, and a status entry;
if said first quality metric falls below said pre-defined quality metric value,
determining a time derivative slope of said first quality metric and storing said time derivative slope of said first quality metric in a first memory location;
switching to a second antenna;
monitoring over a second period of time a second quality metric relating to the use of said second antenna;
if said second quality metric does not fall below said pre-defined quality metric value, remaining with said second antenna, and updating said plurality of memory locations with a time entry, a mode entry, and a status entry;
if said second quality metric relating to the use of said second antenna is less than said pre-defined quality metric value, and said time derivative slope of said first quality metric has an absolute value less than a pre-defined time derivative slope threshold,
switching back to said first antenna and repeating all preceding operations to switch to another antenna when necessary; and
if said second quality metric relating to the use of said second antenna is less than said pre-defined quality metric value, and said time derivative slope of said first quality metric has an absolute value not less than a pre-defined time derivative slope threshold,
switching to a third antenna and repeating all preceding operations with said third antenna substituted in the role of said first antenna.

16. The method of claim 15, further comprising:
updating a plurality of memory locations to indicate a previous antenna, a current antenna, and a next antenna.

17. The method of claim 15, further comprising:
if said at least one second quality metric relating to the use of said second antenna is less than said pre-defined quality metric value, updating at least one index regarding said second antenna with said at least one quality metric relating to the use of said second antenna, and said time derivative slope of said at least one second quality metric.

18. The method of claim 15, wherein said first quality metric must fall below a pre-defined quality metric value, determined by a pre-defined quality metric threshold and by a pre-defined quality metric margin, before starting a switch to said second antenna.

19. The method of claim 15, wherein said first quality metric must fall below a pre-defined quality metric value, determined by a pre-defined quality metric threshold and by a pre-defined quality metric margin, for a pre-defined period of time before starting a switch to said second antenna.

20. The method of claim 15, wherein said first antenna, said second antenna, and said third antenna are used in wideband applications substantially compatible with IEEE 802.16e requirements.
